(19) United States
(12) Patent Application Publication
(10) Pub. No.: US 2012/0161897 A1
(43) Pub. Date: Jun. 28, 2012

(54) DIRECTIONAL COUPLER

(75) Inventors: Ikuo TAMARU, Nagaokakyo-shi (JP); Kiyoshi AIKAWA, Nagaokakyo-shi (JP)

(73) Assignee: MURATA MANUFACTURING CO., LTD., Nagaokakyo-shi (JP)

(21) Appl. No.: 13/411,858

(22) Filed: Mar. 5, 2012

Related U.S. Application Data
(63) Continuation of application No. PCT/JP2010/070537, filed on Nov. 18, 2010.

(30) Foreign Application Priority Data
Dec. 18, 2009 (JP) 2009-287061

(51) Int. Cl. H01P 5/12; H01P 1/213

(52) U.S. Cl. 333/110

(57) ABSTRACT

A directional coupler that has a degree of coupling that is close to constant and is to be used in a predetermined frequency band includes a main line between a first outer electrode and a second outer electrode. A sub-line is provided between a third outer electrode and a fourth outer electrode and is electromagnetically coupled with the main line. A low pass filter is provided between the third outer electrode and the sub-line and has a characteristic in which attenuation increases with increasing frequency in a predetermined frequency band.

### BACKGROUND OF THE INVENTION

1. Field of the Invention

The present invention relates to directional couplers and more particularly relates to directional couplers that are preferably used in, for example, wireless communication devices that perform communication using high-frequency signals.

2. Description of the Related Art

The directional coupler described in Japanese Unexamined Patent Application Publication No. 8-237012 is a known example of a conventional directional coupler. This directional coupler is formed by stacking a plurality of dielectric layers, on which coil-shaped conductors and ground conductors have been formed, on top of one another. Two of the coil-shaped conductors are provided. One of the coil-shaped conductors forms a main line and the other coil-shaped conductor forms a sub-line. The main line and the sub-line are electromagnetically coupled with each other. Furthermore, the coil-shaped conductors are interposed between the ground conductors in the direction in which the layers are stacked. A ground potential is applied to the ground conductors. In the above-described directional coupler, when a signal is input to the main line, a signal is output from the sub-line, the signal having a power that is proportional to the power of the input signal.

However, there is a problem with the directional coupler described in Japanese Unexamined Patent Application Publication No. 8-237012, in that the degree of coupling between the main line and the sub-line becomes higher as the frequency of a signal input to the main line increases (that is, the degree of coupling characteristic is not constant). Consequently, even if signals having the same power are input to the main line, if the frequencies of the signals vary, the powers of the signals output from the sub-line will also vary. Therefore, it is necessary that an IC, which is connected to the sub-line, have a function of correcting the power of a signal on the basis of the frequency of the signal.

### SUMMARY OF THE INVENTION

Accordingly, preferred embodiments of the present invention achieve a degree of coupling characteristic that is close to constant in a directional coupler.

A directional coupler according to a preferred embodiment of the present invention is to be used in a predetermined frequency band and includes first to fourth terminals; a main line that is connected between the first terminal and the second terminal; a first sub-line that is connected between the third terminal and the fourth terminal and that is electromagnetically coupled with the main line; and a first low pass filter that is connected between the third terminal and the first sub-line and has a characteristic in which attenuation increases with increasing frequency in the predetermined frequency band.

According to various preferred embodiments of the present invention, the degree of coupling characteristic can be close to constant in a directional coupler.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is an equivalent circuit diagram of a directional coupler according to any of first to fourth preferred embodiments of the present invention.

FIG. 2 is a graph illustrating a degree of coupling characteristic and an isolation characteristic of a conventional directional coupler that does not contain a low pass filter.

FIG. 3 is a graph illustrating a degree of coupling characteristic of a conventional directional coupler that does not contain a low pass filter and an insertion loss characteristic of a low pass filter.

FIG. 4 is a graph illustrating a degree of coupling characteristic and an isolation characteristic of a directional coupler according to a first preferred embodiment of the present invention.

FIG. 5 is an external perspective view of a directional coupler according to any of first to fifth preferred embodiments of the present invention.

FIG. 6 is an exploded perspective view of a multilayer body of the directional coupler according to the first preferred embodiment of the present invention.

FIG. 7 is an exploded perspective view of a multilayer body of the directional coupler according to the second preferred embodiment of the present invention.

FIG. 8 is an exploded perspective view of a multilayer body of the directional coupler according to the third preferred embodiment of the present invention.

FIG. 9 is an exploded perspective view of a multilayer body of the directional coupler according to the fourth preferred embodiment of the present invention.

FIG. 10 is an exploded perspective view of a multilayer body of the directional coupler according to the fifth preferred embodiment of the present invention.

FIG. 11 is an equivalent circuit diagram of a directional coupler according to a sixth preferred embodiment of the present invention.

FIG. 12 is an external perspective view of a directional coupler according to the sixth or a seventh preferred embodiment of the present invention.

FIG. 13 is an exploded perspective view of a multilayer body of the directional coupler according to the sixth preferred embodiment of the present invention.

FIG. 14 is an exploded perspective view of a multilayer body of the directional coupler according to the seventh preferred embodiment of the present invention.

FIG. 15 is an equivalent circuit diagram of a directional coupler according to an eighth or ninth preferred embodiment of the present invention.

FIG. 16 is an exploded perspective view of the multilayer body of the directional coupler according to the seventh preferred embodiment of the present invention.

FIG. 17 is a graph illustrating a degree of coupling characteristic and an isolation characteristic of a conventional directional coupler that does not contain a low pass filter.

FIG. 18 is a graph illustrating a degree of coupling characteristic and an isolation characteristic of a directional coupler.

FIG. 19 is an exploded perspective view of a multilayer body of the directional coupler according to the ninth preferred embodiment of the present invention.

FIG. 20 is an exploded perspective view of a multilayer body of a directional coupler according to a tenth preferred embodiment of the present invention.

FIG. 21 is an equivalent circuit diagram of a directional coupler according to an eleventh preferred embodiment of the present invention.

FIG. 22 is an exploded perspective view of a multilayer body of the directional coupler according to the eleventh preferred embodiment of the present invention.

FIG. 23 is an equivalent circuit diagram of a directional coupler according to a twelfth preferred embodiment of the present invention.

FIG. 24 is an exploded perspective view of a multilayer body of the directional coupler according to the twelfth preferred embodiment of the present invention.

### DETAILED DESCRIPTION OF THE PREFERRED EMBODIMENTS

Hereafter, directional couplers according to preferred embodiments of the present invention will be described.

### First Preferred Embodiment

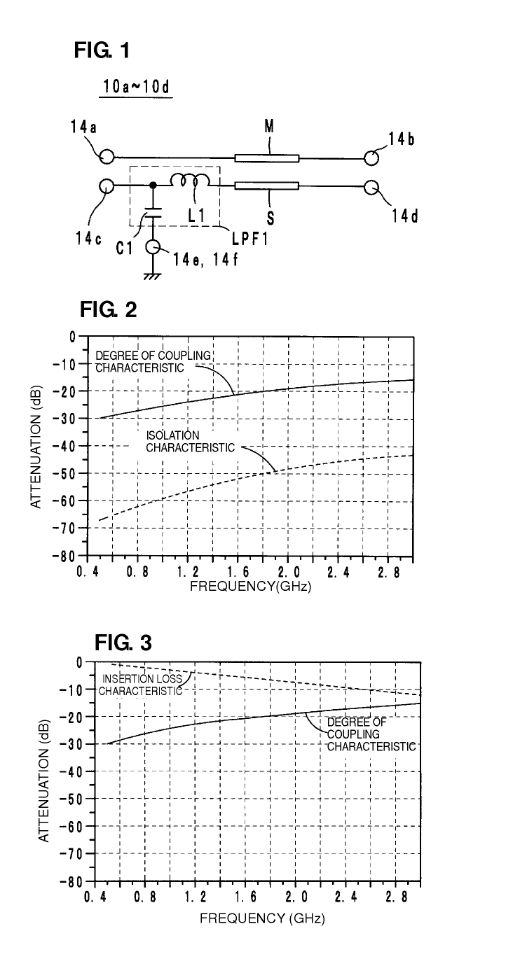

Hereafter, a directional coupler according to a first preferred embodiment will be described while referring to the drawings. FIG. 1 is an equivalent circuit diagram for any of directional couplers 10a to 10d according to first to fourth preferred embodiments of the present invention.

The circuit configuration of the directional coupler 10a will now be described. The directional coupler 10a is to be used in a predetermined frequency band. Examples of the predetermined frequency band include 824 MHz to 1910 MHz in the case where a signal having a frequency of 824 MHz to 915 MHz (GSM 800/900) and a signal having a frequency of 1710 MHz to 1910 MHz (GSM 1800/1900) are input to the directional coupler 10a.

The directional coupler 10a preferably includes outer electrodes (terminals) 14a to 14f, a main line M, a sub-line S and a low pass filter LPF1, as a circuit configuration. The main line M is connected between the outer electrodes 14a and 14b. The sub-line S is connected between the outer electrodes 14c and 14d and is electromagnetically coupled with the main line M.

In addition, the low pass filter LPF1 is connected between the outer electrode 14c and the sub-line S and has a characteristic in which attenuation increases with increasing frequency in a predetermined frequency band. The low pass filter LPF1 includes a capacitor C1 and a coil L1. The coil L1 is connected in series between the outer electrode 14c and the sub-line S. The capacitor C1 is connected between a point between the sub-line S and the outer electrode 14c (more precisely a point between the coil L1 and the outer electrode 14c), and the outer electrodes 14e and 14f.

In the above-described directional coupler 10a, the outer electrode 14a is used as an input port and the outer electrode 14b is used as an output port. Furthermore, the outer electrode 14c is used as a coupling port and the outer electrode 14d is used as a termination port that is terminated at about 50Ω, for example. The outer electrodes 14e and 14f are used as ground ports, which are grounded. When a signal is input to the outer electrode 14a, the signal is output from the outer electrode 14b. Furthermore, since the main line M and the sub-line S are electromagnetically coupled with each other, a signal having a power that is proportional to the power of the input signal is output from the outer electrode 14c.

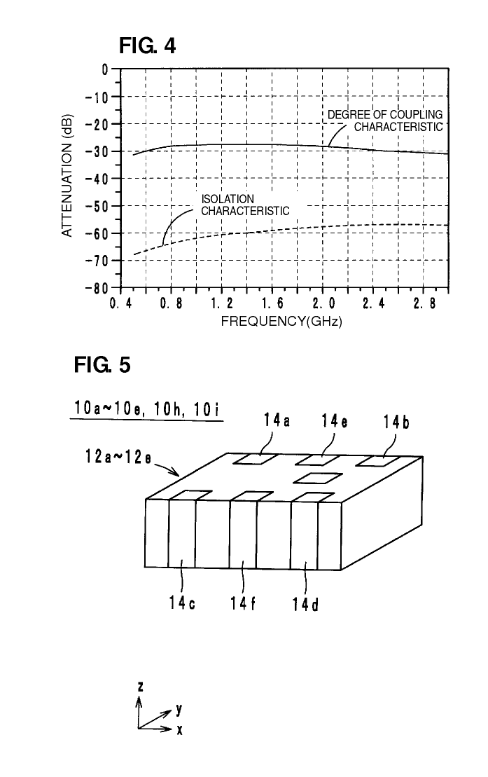

With the directional coupler 10a having the above-described circuit configuration, as will be described below, it is possible to make the degree of coupling characteristic close to constant. FIG. 2 is a graph illustrating a degree of coupling characteristic and an isolation characteristic of a conventional directional coupler that does not contain the low pass filter LPF1. FIG. 3 is a graph illustrating a degree of coupling characteristic of a conventional directional coupler that does not contain the low pass filter LPF1 and an insertion loss characteristic of the low pass filter LPF1. FIG. 4 is a graph illustrating a degree of coupling characteristic and an isolation characteristic of the directional coupler 10a. Simulation results are illustrated in FIGS. 2 to 4. The degree of coupling characteristic is the relation between the ratio of the power of a signal input to the outer electrode 14a (input port) to the power of a signal output from the outer electrode 14c (coupling port) (i.e., attenuation) and frequency. The isolation characteristic is the relation between the ratio of the power of a signal input from the outer electrode 14b (output port) to the power of a signal output from the outer electrode 14c (coupling port) (i.e., attenuation) and frequency. In addition, the insertion loss characteristic is the relation between the attenuation of the low pass filter and frequency. In FIGS. 2 to 4, the vertical axis represents attenuation and the horizontal axis represents frequency.

In the conventional directional coupler, the degree of coupling between the main line and the sub-line increases as the frequency of a signal increases. Therefore, as illustrated in FIG. 2, the ratio of power input from the input port to power output to the coupling port increases with increasing frequency in the degree of coupling characteristic of the conventional directional coupler.

Accordingly, in the directional coupler 10a, the low pass filter LPF1 is connected between the outer electrode 14c and the sub-line S. The low pass filter LPF1, as illustrated in FIG. 3, has an insertion loss characteristic in which attenuation increases with increasing frequency. Consequently, even when the power of a signal output from the sub-line S to the outer electrode 14c increases due to the frequency of the signal increasing, the power of the signal is reduced by the low pass filter LPF1. As a result, as illustrated in FIG. 4, the degree of coupling characteristic can be close to constant in the directional coupler 10a.

In the predetermined frequency band, it is preferable that the average value of the slope of the degree of coupling characteristic for a section of the directional coupler 10a excluding the low pass filter LPF1 (that is, the main line M and the sub-line S) and the average value of the slope of the insertion loss characteristic of the low pass filter LPF1 have opposite signs and have substantially equal absolute values. This makes it possible for the degree of coupling characteristic of the directional coupler 10a to be made even closer to being constant.

Furthermore, comparing the isolation characteristic of the directional coupler 10a illustrated in FIG. 3 and the isolation characteristic of the conventional directional coupler illustrated in FIG. 2, the attenuation of the isolation characteristic is not increased by providing the low pass filter LPF1 in the directional coupler 10a.

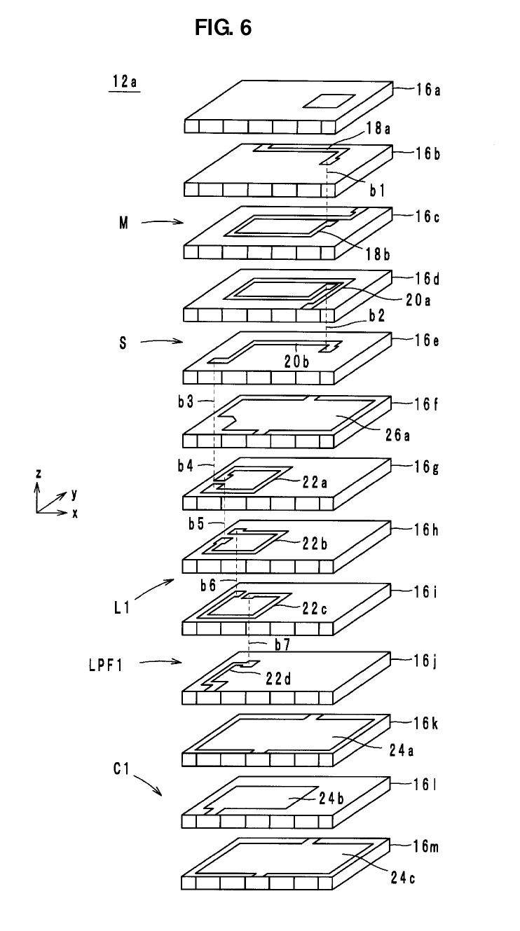

Next, a specific configuration of the directional coupler 10a will be described while referring to the drawings. FIG. 5 is an external perspective view of any of directional couplers 10a to 10e according to first to fifth preferred embodiments. FIG. 6 is an exploded perspective view of a multilayer body 12a of the directional coupler 10a according to the first preferred embodiment. Hereafter, the stacking direction is defined as a z-axis direction, a direction in which long sides of the directional coupler 10a extend when viewed in plan from the z-axis direction is defined as an x-axis direction and a direction in which short sides of the directional coupler 10a extend when viewed in plan from the z-axis direction is defined as a y-axis direction. The x axis, the y axis and the z axis are orthogonal to one another.

The directional coupler 10a, as illustrated in FIG. 5 and FIG. 6, preferably includes the multilayer body 12a, the outer electrodes 14 (14a to 14f), the main line M, the sub-line S, the low pass filter LPF1 and a shielding conductor layer 26a. The multilayer body 12a, as illustrated in FIG. 5, preferably has a rectangular parallelepiped shape, and, as illustrated in FIG. 6, is preferably formed by insulator layers 16 (16a to 16m) being stacked in this order from the positive side to the negative side in the z-axis direction, for example. The insulator layers 16 are dielectric ceramic layers having a rectangular or substantially rectangular shape, for example.

The outer electrodes 14a, 14e and 14b are provided on a lateral surface of the multilayer body 12a on the positive side in the y-axis direction so as to be adjacent to one another in this order from the negative side to the positive side in the x-axis direction. The outer electrodes 14c, 14f and 14d are provided on a lateral surface of the multilayer body 12a on the negative side in the y-axis direction so as to be adjacent to one another in this order from the negative side to the positive side in the x-axis direction.

The main line M, as illustrated in FIG. 6, preferably includes line portions 18 (18a, 18b) and a via hole conductor b1 and has a spiral shape that loops in the clockwise direction while advancing from the positive side to the negative side in the z-axis direction. Here, in the main line M, an end portion on the upstream side in the clockwise direction is termed an upstream end and an end portion on the downstream side in the clockwise direction is termed a downstream end. The line portion 18a is a line-shaped conductor layer that is provided on the insulator layer 16b and the upstream end thereof is connected to the outer electrode 14a. The line portion 18b is a line-shaped conductor layer that is provided on the insulator layer 16c and the downstream end thereof is connected to the outer electrode 14b. The via hole conductor b1 penetrates through the insulator layer 16b in the z-axis direction and connects the downstream end of the line portion 18a and the upstream end of the line portion 18b to each other. In this way, the main line M is connected between the outer electrodes 14a and 14b.

The sub-line S, as illustrated in FIG. 6, preferably includes line portions 20 (20a, 20b) and via hole conductors b2 to b4 and has a spiral shape that loops in the counterclockwise direction while advancing from the positive side to the negative side in the z-axis direction. In other words, the sub-line S loops in the opposite direction to the main line M. Furthermore, a region enclosed by the sub-line S is superposed with a region enclosed by the main line M when viewed in plan from the z-axis direction. That is, the main line M and the sub-line S oppose each other with the insulator layer 16c interposed therebetween. Thus, the main line M and the sub-line S are electromagnetically coupled with each other. Here, in the sub-line S, an end portion on the upstream side in the counterclockwise direction is termed an upstream end and an end portion on the downstream side in the counterclockwise direction is termed a downstream end. The line portion 20a is a line-shaped conductor layer that is provided on the insulator layer 16d and the upstream end thereof is connected to the outer electrode 14d. The line portion 20b is a line-shaped conductor layer that is provided on the insulator layer 16e. The via hole conductor b2 penetrates through the insulator layer 16d in the z-axis direction and connects the downstream end of the line portion 20a and the upstream end of the line portion 20b to each other. In addition, the via hole conductors b3 and b4 penetrate through the insulator layers 16e and 16f in the z-axis direction and are connected to each other. The via hole conductor b3 is connected to the downstream end of the line portion 20b.

The low pass filter LPF1 preferably includes the coil L1 and the capacitor C1. The coil L1 includes line portions 22 (22a to 22d) and via hole conductors b5 to b7 and has a spiral shape that loops in the counterclockwise direction while advancing from the positive side to the negative side in the z-axis direction. Here, in the coil L1, an end portion on the upstream side in the counterclockwise direction is termed an upstream end and an end portion on the downstream side in the counterclockwise direction is termed a downstream end. The line portion 22a is a line-shaped conductor layer that is provided on the insulator layer 16g and the upstream end thereof is connected to the via hole conductor b4. The line portions 22b and 22c are line-shaped conductor layers that are provided on the insulator layers 16h and 16i, respectively. The line portion 22d is a line-shaped conductor layer that is provided on the insulator layer 16j and the downstream end thereof is connected to the outer electrode 14c. The via hole conductor b5 penetrates through the insulator layer 16g in the z-axis direction and connects the downstream end of the line portion 22a and the upstream end of the line portion 22b to each other. The via hole conductor b6 penetrates through the insulator layer 16h in the z-axis direction and connects the downstream end of the line portion 22b and the upstream end of the line portion 22c to each other. The via hole conductor b7 penetrates through the insulator layer 16i in the z-axis direction and connects the downstream end of the line portion 22c and the upstream end of the line portion 22d to each other. In this way, the coil L1 is connected between the sub-line S and the outer electrode 14c.

The capacitor C1 preferably includes planar conductor layers 24 (24a to 24c). The planar conductor layers 24a and 24c are respectively provided so as to cover substantially the entire surfaces of the insulator layers 16k and 16m and are connected to the outer electrodes 14e and 14f. The planar conductor layer 24b is provided on the insulator layer 16l and is connected to the outer electrode 14c. The planar conductor layer 24b preferably has a rectangular or substantially rectangular shape and is superposed with the planar conductor layers 24a and 24c when viewed in plan from the z-axis direction. In this way, a capacitance is generated between the planar conductor layers 24a and 24c and the planar conductor layer 24b. The capacitor C1 is connected between the outer electrode 14c and the outer electrodes 14e and 14f. That is, the capacitor C1 is connected between a point between the coil L1 and the outer electrode 14c, and the outer electrodes 14e and 14f.

The shielding conductor layer 26a is arranged so as to cover substantially the entire surface of the insulator layer 16f and is connected to the outer electrodes 14e and 14f. That is, a ground potential is applied to the shielding conductor layer 26a. The shielding conductor layer 26a is provided between the main line M and the sub-line S, and the coil L1 in the z-axis direction such that electromagnetic coupling between the sub-line S and the coil L1 is prevented and suppressed.

### Second Preferred Embodiment

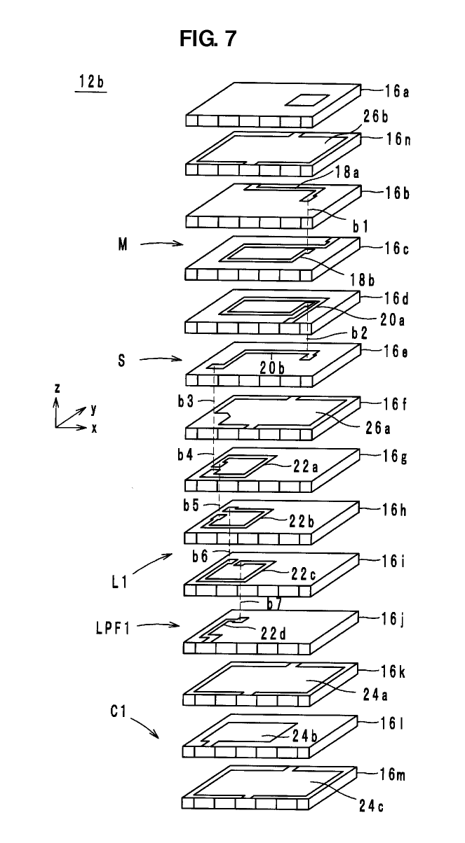

Hereafter, the configuration of a directional coupler 10b according to a second preferred embodiment will be described while referring to the drawings. FIG. 7 is an exploded perspective view of a multilayer body 12b of the directional coupler 10b according to the second preferred embodiment.

The circuit configuration of the directional coupler 10b preferably is the same as that of the directional coupler 10a and therefore description thereof will be omitted. A difference between the directional coupler 10b and the directional coupler 10a is that, as illustrated in FIG. 7, an insulator layer 16n, on which a shielding conductor layer 26b is provided, is provided between the insulator layers 16a and 16b.

More specifically, the shielding conductor layer 26b is provided so as to cover substantially the entire surface of the insulator layer 16n and is connected to the outer electrodes 14e and 14f. That is, a ground potential is applied to the shielding conductor layer 26b. The shielding conductor layer 26b is provided on the positive side of the main line M in the z-axis direction. In this way, the shielding conductor layer 26b is arranged such that the main line M, the sub-line S and the coil L1 are interposed between the shielding conductor layer 26b and the planar conductor layers 24a and 24c in the z-axis direction. Thus, leakage of magnetic fields generated by the main line M, the sub-line S and the coil L1 to outside of the multilayer body 12b is prevented by the shielding conductor layer 26b and the planar conductor layers 24a and 24c.

### Third Preferred Embodiment

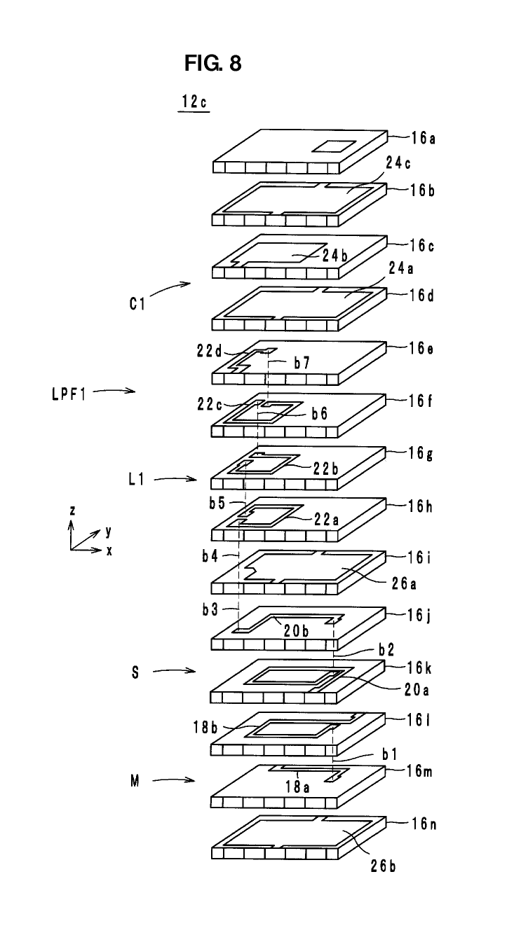

Hereafter, the configuration of a directional coupler 10c according to a third preferred embodiment will be described while referring to the drawings. FIG. 8 is an exploded perspective view of a multilayer body 12c of the directional coupler 10c according to the third preferred embodiment.

The circuit configuration of the directional coupler 10c preferably is the same as that of the directional couplers 10a and 10b and therefore description thereof will be omitted. A difference between the directional coupler 10c and the directional coupler 10b is that the order in which the main line M, the sub-line S, the low pass filter LPF1 (coil L1 and capacitor C1), and the shielding conductor layers 26a and 26b are stacked is different.

More specifically, in the directional coupler 10b, as illustrated in FIG. 7, the shielding conductor layer 26b, the main line M, the sub-line S, the shielding conductor layer 26a, the coil L1 and the capacitor C1 are arranged in this order from the positive side to the negative side in the z-axis direction. In contrast, in the directional coupler 10c, as illustrated in FIG. 8, the capacitor C1, the coil L1, the shielding conductor layer 26a, the sub-line S, the main line M and the shielding conductor layer 26b are arranged in this order from the positive side to the negative side in the z-axis direction.

With the directional coupler 10c having the above-described configuration, it is also possible to make the degree of coupling characteristic close to being constant while preventing the magnetic fields generated by the main line M, the sub-line S and the coil L1 from leaking to the outside, similarly to the directional coupler 10b.

### Fourth Preferred Embodiment

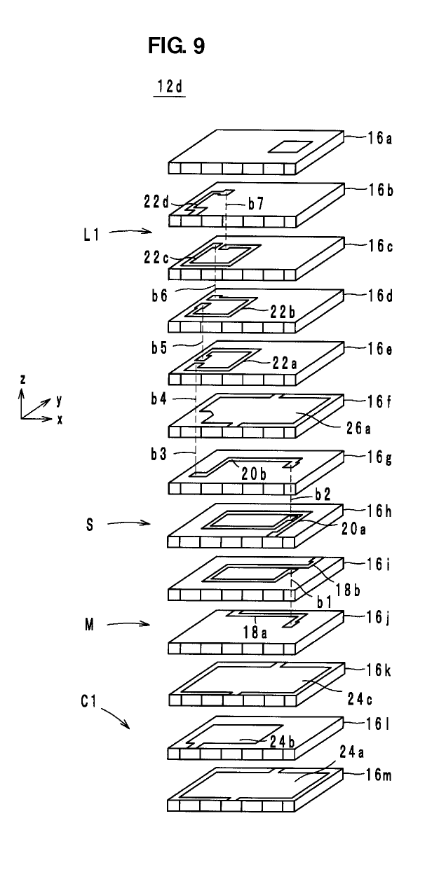

Hereafter, the configuration of a directional coupler 10d according to a fourth preferred embodiment will be described while referring to the drawings. FIG. 9 is an exploded perspective view of a multilayer body 12d of the directional coupler 10d according to the fourth preferred embodiment.

The circuit configuration of the directional coupler 10d preferably is the same as that of the directional couplers 10a and 10b and therefore description thereof will be omitted. A difference between the directional coupler 10d and the directional coupler 10a is that the order in which the main line M, the sub-line S, the low pass filter LPF1 (coil L1 and capacitor C1), and the shielding conductor layer 26a are stacked is different.

More specifically, in the directional coupler 10a, as illustrated in FIG. 6, the main line M, the sub-line S, the shielding conductor layer 26a, the coil L1 and the capacitor C1 are arranged in this order from the positive side to the negative side in the z-axis direction. In contrast, in the directional coupler 10d, as illustrated in FIG. 9, the coil L1, the shielding conductor layer 26a, the sub-line S, the main line M and the capacitor C1 are arranged in this order from the positive side to the negative side in the z-axis direction.

With the directional coupler 10d having the above-described configuration, it is also possible to make the degree of coupling characteristic close to constant, similarly to the directional coupler 10a.

In addition, in the directional coupler 10d, the capacitor C1 is provided on the negative side of the main line M and the sub-line S in the z-axis direction. Thus, the main line M and the sub-line S are interposed between the planar conductor layers 24a and 24c, and the shielding conductor layer 26a in the z-axis direction. Therefore, leaking of the magnetic fields generated by the main line M and the sub-line S to outside of the multilayer body 12d is prevented by the planar conductor layers 24a and 24c and the shielding conductor layer 26a. That is, in the directional coupler 10d, there is no need to additionally provide another shielding conductor layer 26 to prevent leaking of the magnetic fields generated by the main line M and the sub-line S to outside of the multilayer body 12d.

### Fifth Preferred Embodiment

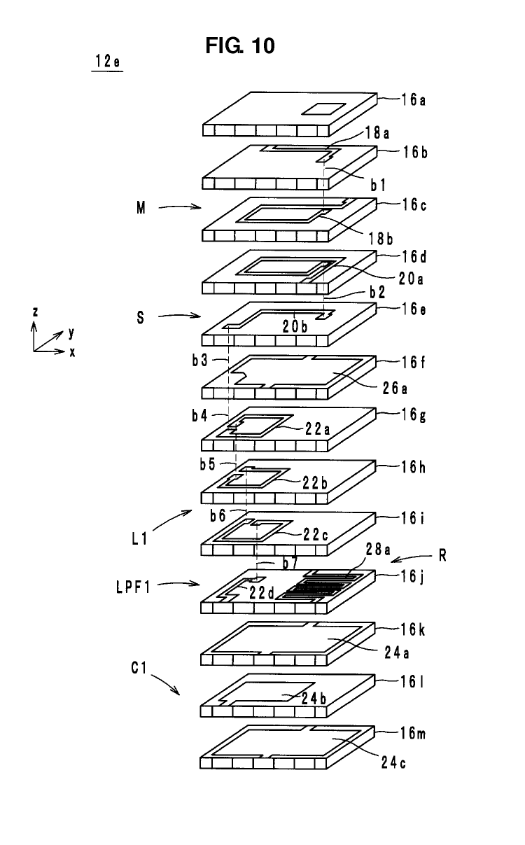

Hereafter, the configuration of a directional coupler 10e according to a fifth preferred embodiment will be described while referring to the drawings. FIG. 10 is an exploded perspective view of a multilayer body 12e of the directional coupler 10e according to the fifth preferred embodiment.

The directional coupler 10e preferably has a circuit configuration in which a termination resistor R, which is provided to terminate the outer electrode 14d, is additionally provided between the outer electrode 14d and the outer electrode 14e in the circuit configuration of the directional coupler 10a illustrated in FIG. 1. In the directional coupler 10e, as illustrated in FIG. 10, a resistance conductor layer 28a, which serves as the termination resistor R, is provided on the insulator layer 16j.

More specifically, the resistance conductor layer 28a, as illustrated in FIG. 10, is a meandering line-shaped conductor layer that is connected between the outer electrode 14d and the outer electrode 14e. The resistance conductor layer 28a, for example, has an impedance of about 50Ω. Thus, it is also possible to build the termination resistor R into the directional coupler 10e. In this case, compared with when the termination resistor is provided on the outside, the substrate on which this directional coupler is to be mounted can be reduced in size by the amount of space that would have been taken up by the termination resistor.

### Sixth Preferred Embodiment

Hereafter, a directional coupler according to a sixth preferred embodiment will be described while referring to the drawings. FIG. 11 is an equivalent circuit diagram of a directional coupler 10f according to the sixth preferred embodiment.

The circuit configuration of the directional coupler 10f will now be described. The configuration of the low pass filter LPF1 of the directional coupler 10f is different from the configuration of the low pass filter LPF1 of the directional coupler 10a. Specifically, in the low pass filter LPF1 of the directional coupler 10a, the capacitor C1 is connected between a point between the outer electrode 14c and the coil L1, and the outer electrodes 14e and 14f, as illustrated in FIG. 1. In contrast, in the low pass filter LPF1 of the directional coupler 10f, the capacitor C1 is connected between a point between the sub-line S and the coil L1, and the outer electrode 14e, as illustrated in FIG. 11. Thus, an unwanted signal, among signals output to the outer electrode 14c side from the sub-line S, is output to outside of the directional coupler 10f via the capacitor C1 and the outer electrode 14e, without passing through the coil L1. Consequently, returning of such an unwanted signal to the sub-line S side after being reflected by the coil L1 is prevented.

In addition, in the directional coupler 10f, a low pass filter LPF2 is additionally provided to the configuration of the directional coupler 10a. Specifically, the low pass filter LPF2 is connected between the outer electrode 14d and the sub-line S and has a characteristic that attenuation increases with increasing frequency. The low pass filter LPF2 includes a capacitor C2 and a coil L2. The coil L2 is connected in series between the outer electrode 14d and the sub-line S. The capacitor C2 is connected between a point between the sub-line S and the outer electrode 14d (more precisely a point between the coil L2 and the sub-line S), and the outer electrode 14f.

The above-described directional coupler 10f can use both the outer electrodes 14c and 14d as coupling ports. More specifically, in a first method of using the directional coupler 10f, similarly to as with the directional coupler 10a, the outer electrode 14a is used as an input port and the outer electrode 14b is used as an output port. The outer electrode 14c is used as a coupling port and the outer electrode 14d is used as a termination port. The outer electrodes 14e and 14f are used as termination ports. In this case, when a signal is input to the outer electrode 14a, the signal is output from the outer electrode 14b. Furthermore, since the main line M and the sub-line S are electromagnetically coupled with each other, a signal having a power that is proportional to the power of the input signal is output from the outer electrode 14c.

In addition, in a second method of using the directional coupler 10f, the outer electrode 14b is used as an input port and the outer electrode 14a is used as an output port. The outer electrode 14d is used as a coupling port and the outer electrode 14c is used as a termination port. The outer electrodes 14e and 14f are used as termination ports. In this case, when a signal is input to the outer electrode 14b, the signal is output from the outer electrode 14a. Furthermore, since the main line M and the sub-line S are electromagnetically coupled with each other, a signal having a power that is proportional to the power of the input signal is output from the outer electrode 14d.

The above-described directional coupler 10f, for example, can be applied to transmission and reception circuits of wireless communication terminals such as cellular phones. That is, when detecting the power of a transmission signal, 14a may serve as an input port and when detecting the power of reflection from an antenna, the outer electrode 14b may serve as an input port. In the directional coupler 10f, even though either of the outer electrodes 14a and 14b may be used as an input port, since the low pass filters LPF1 and LPF2 are provided, it is possible to make the degree of coupling characteristic close to constant.

In addition, in the directional coupler 10f, termination resistors R1 and R2 are connected between the outer electrodes 14g and 14h and the ground potential. Thus, the occurrence of reflection of signals from the outer electrodes 14g and 14h toward the outer electrodes 14c and 14d via the low pass filters LPF1 and LPF2 is prevented and suppressed.

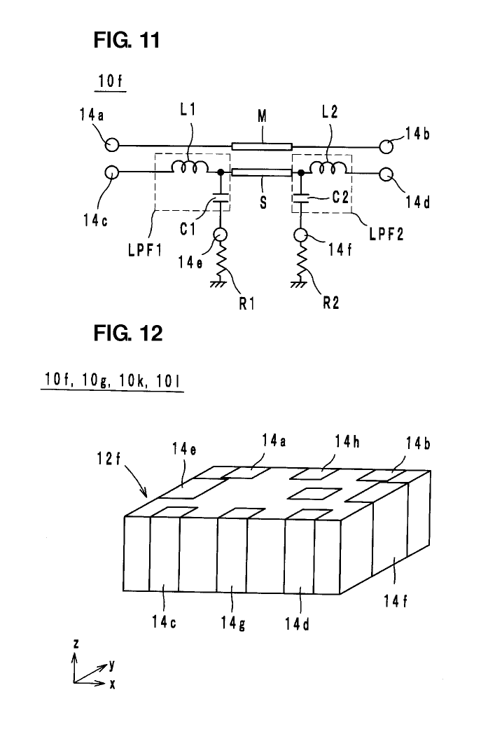

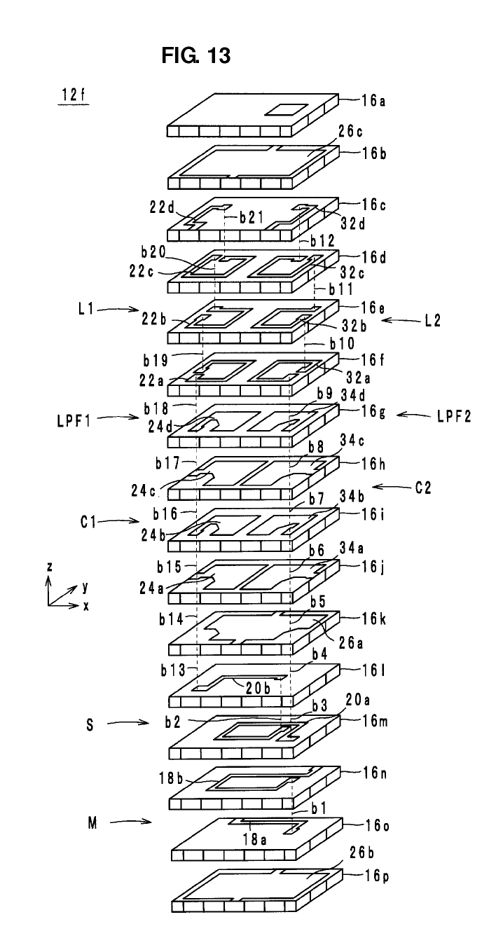

Next, a specific configuration of the directional coupler 10f will be described while referring to the drawings. FIG. 12 is an external perspective view of either of directional couplers 10f and 10g according to the sixth preferred embodiment and a seventh preferred embodiment. FIG. 13 is an exploded perspective view of a multilayer body 12f of the directional coupler 10f according to the sixth preferred embodiment. Hereafter, the stacking direction is defined as a z-axis direction, a direction in which long sides of the directional coupler 10f extend when viewed in plan from the z-axis direction is defined as an x-axis direction and a direction in which short sides of the directional coupler 10f extend when viewed in plan from the z-axis direction is defined as a y-axis direction. The x axis, the y axis and the z axis are orthogonal to one another.

The directional coupler 10f, as illustrated in FIG. 12 and FIG. 13, includes the multilayer body 12f, the outer electrodes 14 (14a to 14h), the main line M, the sub-line S, the low pass filters LPF1 and LPF2 and shielding conductor layers 26 (26a to 26c). The multilayer body 12f, as illustrated in FIG. 12, preferably has a rectangular parallelepiped shape, and, as illustrated in FIG. 13, and preferably is formed by insulator layers 16 (16a to 16p) being stacked in this order from the positive side to the negative side in the z-axis direction. The insulator layers 16 preferably are dielectric ceramic layers having a rectangular or substantially rectangular shape, for example.

The outer electrodes 14a, 14h and 14b are provided on a lateral surface of the multilayer body 12f on the positive side in the y-axis direction so as to be adjacent to one another in this order from the negative side to the positive side in the x-axis direction. The outer electrodes 14c, 14g and 14d are provided on a lateral surface of the multilayer body 12f on the negative side in the y-axis direction so as to be adjacent to one another in this order from the negative side to the positive side in the x-axis direction. The outer electrode 14e is provided on a lateral surface of the multilayer body 12f on the negative side in the x-axis direction. The outer electrode 14f is provided on a lateral surface of the multilayer body 12f on the positive side in the x-axis direction.

The main line M, as illustrated in FIG. 13, preferably includes the line portions 18 (18a, 18b) and the via hole conductor b1 and has a spiral shape that loops in the counterclockwise direction while advancing from the positive side to the negative side in the z-axis direction. Here, in the main line M, an end portion on the upstream side in the counterclockwise direction is termed an upstream end and an end portion on the downstream side in the counterclockwise direction is termed a downstream end. The line portion 18a is a line-shaped conductor layer that is provided on the insulator layer 16o and the downstream end thereof is connected to the outer electrode 14a. The line portion 18b is a line-shaped conductor layer that is provided on the insulator layer 16n and the upstream end thereof is connected to the outer electrode 14b. The via hole conductor b1 penetrates through the insulator layer 16n in the z-axis direction and connects the upstream end of the line portion 18a and the downstream end of the line portion 18b to each other. In this way, the main line M is connected between the outer electrodes 14a and 14b.

The sub-line S, as illustrated in FIG. 13, preferably includes the line portions 20 (20a, 20b) and via hole conductors b2 to b6 and b13 to b15 and has a spiral shape that loops in the clockwise direction while advancing from the positive side to the negative side in the z-axis direction. In other words, the sub-line S loops in the opposite direction to the main line M. Furthermore, a region enclosed by the sub-line S is superposed with a region enclosed by the main line M when viewed in plan from the z-axis direction. That is, the main line M and the sub-line S oppose each other with the insulator layer 16m therebetween. Thus, the main line M and the sub-line S are electromagnetically coupled with each other. Here, in the sub-line S, an end portion on the upstream side in the clockwise direction is termed an upstream end and an end portion on the downstream side in the clockwise direction is termed a downstream end. The line portion 20a is a line-shaped conductor layer that is provided on the insulator layer 16m. The line portion 20b is a line-shaped conductor layer that is provided on the insulator layer 16l. The via hole conductor b2 penetrates through the insulator layer 16l in the z-axis direction and connects the upstream end of the line portion 20a and the downstream end of the line portion 20b to each other. In addition, the via hole conductors b3, b4, b5 and b6 respectively penetrate through the insulator layers 16l, 16k, 16j and 16i in the z-axis direction and are connected to one another. The via hole conductor b3 is connected to the downstream end of the line portion 20a. In addition, the via hole conductors b13, b14 and b15 respectively penetrate through the insulator layers 16k, 16j and 16i in the z-axis direction and are connected to one another. The via hole conductor b13 is connected to the upstream end of the line portion 20b.

The low pass filter LPF1 preferably includes the coil L1 and the capacitor C1. The capacitor C1 preferably includes the planar conductor layers 24 (24a to 24d) and via hole conductors b16 and b17. The planar conductor layers 24a and 24c preferably are rectangular-shaped conductor layers that are respectively provided on the insulator layers 16j and 16h and are connected to the outer electrode 14e. The planar conductor layers 24b and 24d are provided on the insulator layers 16i and 16g. The planar conductor layers 24b and 24d preferably have a rectangular or substantially rectangular shape and are superposed with the planar conductor layers 24a and 24c when viewed in plan from the z-axis direction. In this way, a capacitance is generated between the planar conductor layers 24a and 24c and the planar conductor layers 24b and 24d. The via hole conductors b16 and b17 respectively penetrate through the insulator layers 16h and 16g and are connected to each other. The via hole conductors b16 and b17 connect the planar conductor layers 24b and 24d to each other. In addition, the via hole conductor b15 is connected to the planar conductor layer 24b. In this way, the capacitor C1 is connected to the upstream end of the sub-line S.

The coil L1 preferably includes the line portions (22a to 22d) and the via hole conductors b18 to b21 and has a spiral shape that loops in the clockwise direction while advancing from the positive side to the negative side in the z-axis direction. Here, in the coil L1, an end portion on the upstream side in the clockwise direction is termed an upstream end and an end portion on the downstream side in the clockwise direction is termed a downstream end. The line portions 22a, 22b and 22c are line-shaped conductor layers that are provided on the insulator layers 16f, 16e and 16d, respectively. The line portion 22d is a line-shaped conductor layer that is provided on the insulator layer 16c and the upstream end thereof is connected to the outer electrode 14c. The via hole conductor b18 penetrates through the insulator layer 16f in the z-axis direction and connects the downstream end of the line portion 22a and the planar conductor layer 24d to each other. The via hole conductor b19 penetrates through the insulator layer 16e in the z-axis direction and connects the upstream end of the line portion 22a and the downstream end of the line portion 22b to each other. The via hole conductor b20 penetrates through the insulator layer 16d in the z-axis direction and connects the upstream end of the line portion 22b and the downstream end of the line portion 22c to each other. The via hole conductor b21 penetrates through the insulator layer 16c in the z-axis direction and connects the upstream end of the line portion 22c and the downstream end of the line portion 22d to each other. In this way, the coil L1 is connected between the capacitor C1 and the sub-line S and the outer electrode 14c.

The low pass filter LPF2 preferably includes the coil L2 and the capacitor C2. The capacitor C2 preferably includes planar conductor layers 34 (34a to 34d) and the via hole conductors b7 and b8. The planar conductor layers 34a and 34c preferably are rectangular-shaped conductor layers that are respectively provided on the insulator layers 16j and 16h and connected to the outer electrode 14f. The planar conductor layers 34b and 34d are provided on the insulator layers 16i and 16g. The planar conductor layers 34b and 34d preferably have a rectangular or substantially rectangular shape and are superposed with the planar conductor layers 34a and 34c when viewed in plan from the z-axis direction. In this way, a capacitance is generated between the planar conductor layers 34a and 34c and the planar conductor layers 34b and 34d. The via hole conductors b7 and b8 respectively penetrate through the insulator layers 16h and 16g and are connected to each other. The via hole conductors b7 and b8 connect the planar conductor layers 34b and 34d to each other. In addition, the via hole conductor b6 is connected to the planar conductor layer 34b. In this way, the capacitor C2 is connected to the downstream end of the sub-line S.

The coil L2 preferably includes line portions 32 (32a to 32d) and via hole conductors b9 to b12 and has a spiral shape that loops in the counterclockwise direction while advancing from the positive side to the negative side in the z-axis direction. Here, in the coil L2, an end portion on the upstream side in the counterclockwise direction is termed an upstream end and an end portion on the downstream side in the counterclockwise direction is termed a downstream end. The line portions 32a, 32b and 32c are line-shaped conductor layers that are provided on the insulator layers 16f, 16e and 16d, respectively. The line portion 32d is a line-shaped conductor layer that is provided on the insulator layer 16c and the upstream end thereof is connected to the outer electrode 14d. The via hole conductor b9 penetrates through the insulator layer 16f in the z-axis direction and connects the downstream end of the line portion 32a and the planar conductor layer 34d to each other. The via hole conductor b10 penetrates through the insulator layer 16e in the z-axis direction and connects the upstream end of the line portion 32a and the downstream end of the line portion 32b to each other. The via hole conductor b11 penetrates through the insulator layer 16d in the z-axis direction and connects the upstream end of the line portion 32b and the downstream end of the line portion 32c to each other. The via hole conductor b12 penetrates through the insulator layer 16c in the z-axis direction and connects the upstream end of the line portion 32c and the downstream end of the line portion 32d to each other. In this way, the coil L2 is connected between the capacitor C2 and the sub-line S and the outer electrode 14c.

The shielding conductor layer 26a is arranged so as to cover substantially the entire surface of the insulator layer 16k and is connected to the outer electrodes 14g and 14h. That is, a ground potential is applied to the shielding conductor layer 26a. The shielding conductor layer 26a is provided between the sub-line S and the capacitors C1 and C2 and suppresses electromagnetic coupling between the sub-line S and the capacitors C1 and C2.

The shielding conductor layers 26b and 26c are arranged so as to cover substantially the entire surfaces of the insulator layers 16p and 16b and are connected to the outer electrodes 14g and 14h. That is, a ground potential is applied to the shielding conductor layers 26b and 26c. The shielding conductor layer 26b is provided on the negative side of the main line M and the sub-line S in the z-axis direction. In addition, the shielding conductor layer 26c is provided on the positive side of the coils L1 and L2 in the z-axis direction. Thus, as for the shielding conductor layers 26b and 26c, leaking of the magnetic fields generated by the main line M, the sub-line S and the coils L1 and L2 to outside of the multilayer body 12f is prevented by the shielding conductor layer 26b. Furthermore, since the coils L1 and L2 preferably have spiral shapes that loop in opposite directions to each other, the magnetic fields generated between these two coils flow in opposite directions and coupling of magnetic fields between the coils can be prevented and suppressed. Thus, coupling between coupling ports and termination ports can be prevented and suppressed and isolation characteristics can be improved.

### Seventh Preferred Embodiment

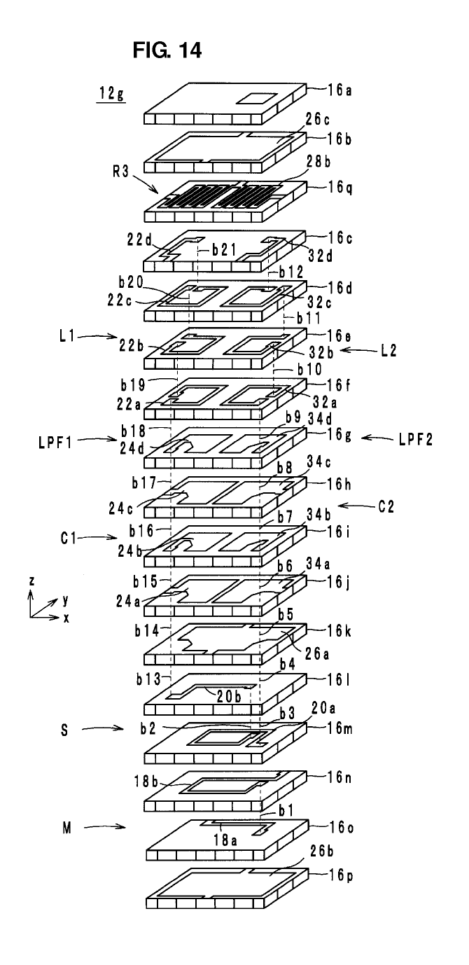

Hereafter, the configuration of a directional coupler 10g according to a seventh preferred embodiment will be described while referring to the drawings. FIG. 14 is an exploded perspective view of a multilayer body 12g of the directional coupler 10g according to the seventh preferred embodiment.

In the directional coupler 10g, a termination resistor R3, which is provided to terminate the outer electrodes 14e and 14f, is connected between the outer electrodes 14e and 14h and between the outer electrodes 14f and 14h, so as to replace the termination resistors R1 and R2 in the circuit configuration of the directional coupler 10f illustrated in FIG. 11. Thus, the capacitor C1 is connected between a point between the outer electrode 14c and the sub-line S (more precisely a point between the coil L1 and the sub-line S), and the termination resistor R3. Furthermore, the capacitor C2 is connected between a point between the outer electrode 14d and the sub-line S (more precisely between the coil L2 and the sub-line S), and the termination resistor R3. A potential such as a ground potential or the like is not applied to the outer electrodes 14e and 14f. On the other hand, the outer electrode 14h is used as a grounding terminal to which a ground potential is applied. In order to satisfy the above-described configuration, in the directional coupler 10g, as illustrated in FIG. 14, an insulator layer 16q is provided, on which a resistance conductor layer 28b is provided as the termination resistor R3.

More specifically, the resistance conductor layer 28b, as illustrated in FIG. 14, is arranged so as to be connected between the outer electrodes 14e and 14h and between the outer electrodes 14f and 14h and is a conductor layer having a meandering shape. The resistance conductor layer 28b, for example, has an impedance of about 50Ω. In this way, the capacitors C1 and C2 are terminated by the resistance conductor layer 28b. Thus, it is also possible to build the termination resistor R3 into the directional coupler 10g. In this case, compared with when the termination resistor is provided on the outside, the substrate on which this directional coupler 10g is to be mounted can be reduced in size by the amount of space that would have been taken up by the termination resistor R3.

### Eighth Preferred Embodiment

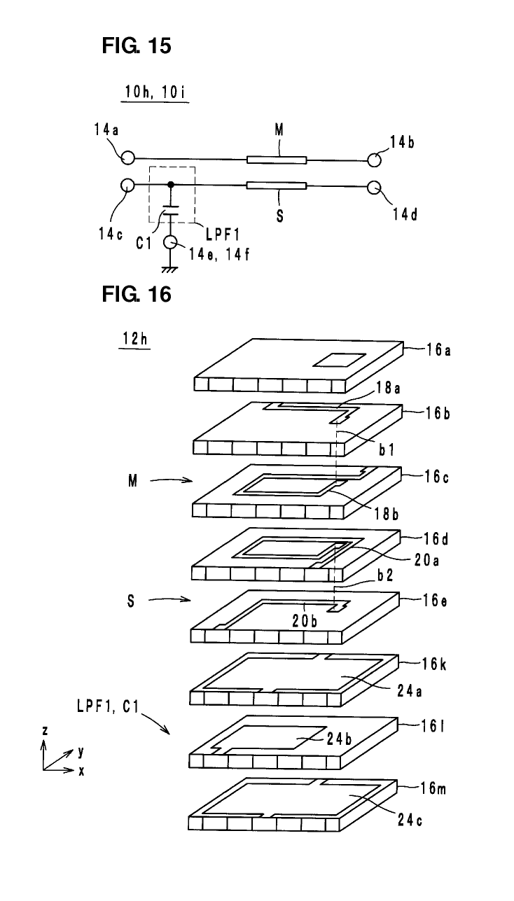

Hereafter, the configuration of a directional coupler 10h according to an eighth preferred embodiment will be described while referring to the drawings. FIG. 15 is an equivalent circuit diagram for directional couplers 10h and 10i according to the eighth preferred embodiment and a ninth preferred embodiment. FIG. 16 is an exploded perspective view of a multilayer body 12h of the directional coupler 10h according to the seventh preferred embodiment.

The directional coupler 10h, as illustrated in FIG. 15, has a circuit configuration in which the coil L1 of the directional coupler 10a illustrated in FIG. 1 and FIG. 6 is not provided. Therefore, the directional coupler 10h, as illustrated in FIG. 16, does not include the insulator layers 16f to 16j, the line portions 22a to 22d, the shielding conductor layer 26a and the via hole conductors b3 to b7. The line portion 20b is connected to the outer electrode 14c.

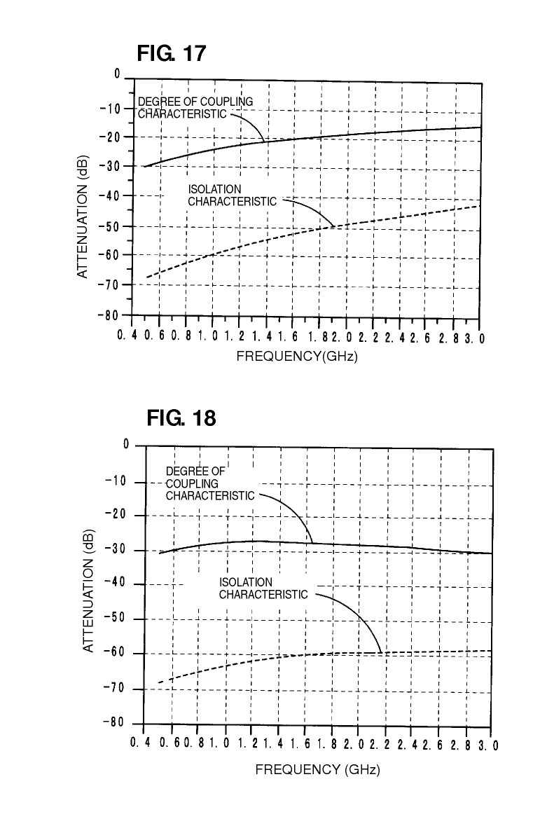

As described above, even if the low pass filter LPF1 includes only the capacitor C1 without using the coil L1, as in the directional coupler 10h, it is possible to make the degree of coupling characteristic close to constant. FIG. 17 is a graph illustrating a degree of coupling characteristic and an isolation characteristic of a conventional directional coupler that does not contain the low pass filter LPF1. FIG. 18 is a graph illustrating a degree of coupling characteristic and an isolation characteristic of the directional coupler 10h. In FIG. 17 and FIG. 18, the vertical axis represents attenuation and the horizontal axis represents frequency.

In the conventional directional coupler, the degree of coupling between the main line and the sub-line increases with increasing frequency of the signal. Therefore, as illustrated in FIG. 17, the ratio of power input from the input port to power output to the coupling port increases with increasing frequency in the degree of coupling characteristic of the conventional directional coupler.

Accordingly, in the directional coupler 10h, the low pass filter LPF1 is connected between the outer electrode 14c and the sub-line S. The low pass filter LPF1 has an insertion loss characteristic in which attenuation increases with increasing frequency. Consequently, even when the power of a signal output from the sub-line S to the outer electrode 14c increases due to the frequency of the signal increasing, the power of the signal is reduced by the low pass filter LPF1. As a result, as illustrated in FIG. 18, the degree of coupling characteristic can be close to constant in the directional coupler 10h.

Furthermore, comparing the isolation characteristic of the directional coupler 10h illustrated in FIG. 18 and the isolation characteristic of the conventional directional coupler illustrated in FIG. 17, the attenuation of the isolation characteristic is not increased by providing the low pass filter LPF1.

### Ninth Preferred Embodiment

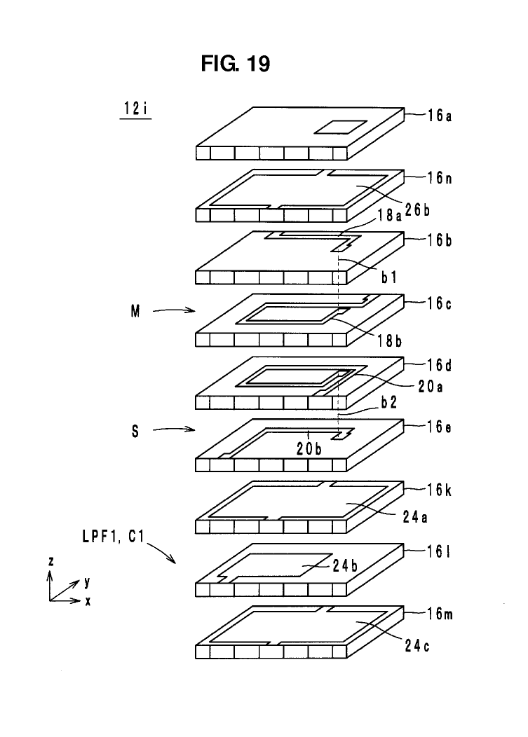

Hereafter, the configuration of a directional coupler 10i according to a ninth preferred embodiment will be described while referring to the drawings. FIG. 19 is an exploded perspective view of a multilayer body 12i of the directional coupler 10i according to the ninth preferred embodiment.

The circuit configuration of the directional coupler 10i is the same as that of the directional coupler 10h and therefore description thereof will be omitted. A difference between the directional coupler 10i and the directional coupler 10h is that, as illustrated in FIG. 19, the insulator layer 16n, on which the shielding conductor layer 26b is provided, is provided between the insulator layers 16a and 16b.

More specifically, the shielding conductor layer 26b is arranged so as to cover substantially the entire surface of the insulator layer 16n and is connected to the outer electrodes 14e and 14f. That is, a ground potential is applied to the shielding conductor layer 26b. The shielding conductor layer 26b is provided on the positive side of the main line M in the z-axis direction. In this way, the shielding conductor layer 26b is arranged so that the main line M and the sub-line S are interposed between the shielding conductor layer 26b and the planar conductor layers 24a and 24c in the z-axis direction. Thus, leakage of magnetic fields generated by the main line M and the sub-line S to outside of the multilayer body 12i can be prevented by the shielding conductor layer 26b and the planar conductor layers 24a and 24c.

### Tenth Preferred Embodiment

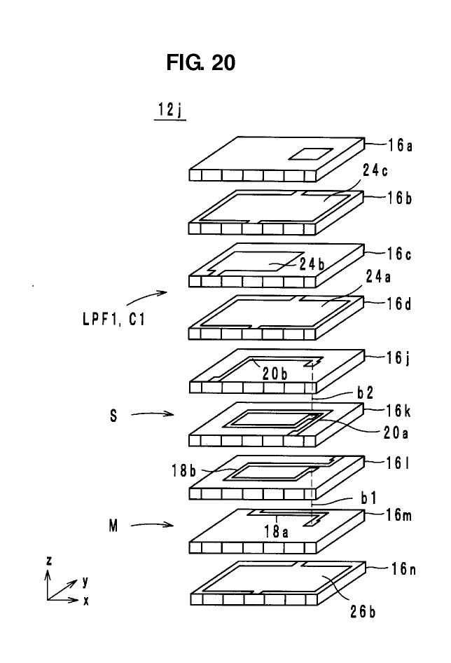

Hereafter, the configuration of a directional coupler 10j according to a tenth preferred embodiment will be described while referring to the drawings. FIG. 20 is an exploded perspective view of a multilayer body 12j of the directional coupler 10j according to the tenth preferred embodiment.

The circuit configuration of the directional coupler 10j preferably is the same as that of the directional couplers 10h and 10i and therefore description thereof will be omitted. A difference between the directional coupler 10j and the directional coupler 10i is that the order in which the main line M, the sub-line S, the low pass filter LPF1 (capacitor C1), and the shielding conductor layer 26b are stacked is different.

More specifically, in the directional coupler 10i, as illustrated in FIG. 19, the shielding conductor layer 26b, the main line M, the sub-line S and the capacitor C1 are arranged in this order from the positive side to the negative side in the z-axis direction. In contrast, in the directional coupler 10j, as illustrated in FIG. 20, the capacitor C1, the sub-line S, the main line M and the shielding conductor layer 26b are arranged in this order from the positive side to the negative side in the z-axis direction.

With the directional coupler 10j having the above-described configuration, it is also possible to make the degree of coupling characteristic close to constant while preventing the magnetic fields generated by the main line M and the sub-line S from leaking to the outside, similarly to the directional coupler 10i.

### Eleventh Preferred Embodiment

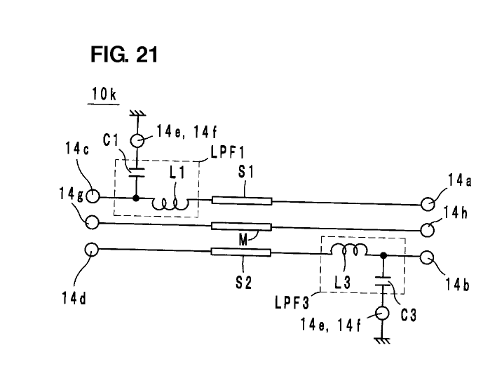

Hereafter, the configuration of a directional coupler 10k according to an eleventh preferred embodiment will be described while referring to the drawings. FIG. 21 is an equivalent circuit diagram of the directional coupler 10k according to the eleventh preferred embodiment.

The circuit configuration of the directional coupler 10k will now be described. The directional coupler 10k preferably includes the outer electrodes (terminals) 14a to 14h, the main line M, sub-lines S1 and S2 and low pass filters LPF1 and LPF3, as a circuit configuration. The main line M is connected between the outer electrodes 14g and 14h. The sub-line S1 is connected between the outer electrodes 14c and 14a and is electromagnetically coupled with the main line M. The sub-line S2 is connected between the outer electrodes 14d and 14b and is electromagnetically coupled with the main line M.

In addition, the low pass filter LPF1 is connected between the outer electrode 14c and the sub-line S1 and has a characteristic that attenuation increases with increasing frequency in a predetermined frequency band. The low pass filter LPF1 includes the capacitor C1 and the coil L1. The coil L1 is connected in series between the outer electrode 14c and the sub-line S1. The capacitor C1 is connected between a point between the sub-line S1 and the outer electrode 14c (more precisely a point between the coil L1 and the outer electrode 14c), and the outer electrodes 14e and 14f.

In addition, the low pass filter LPF3 is connected between the outer electrode 14b and the sub-line S2 and has a characteristic that attenuation increases with increasing frequency in a predetermined frequency band. The low pass filter LPF3 includes a capacitor C3 and a coil L3. The coil L3 is connected in series between the outer electrode 14b and the sub-line S2. The capacitor C3 is connected between a point between the sub-line S2 and the outer electrode 14b (more precisely a point between the coil L3 and the outer electrode 14b), and the outer electrodes 14e and 14f.

In the above-described directional coupler 10k, the outer electrode 14g is used as an input port and the outer electrode 14h is used as an output port. Furthermore, the outer electrode 14c is used as a first coupling port and the outer electrode 14a is used as a termination port that is terminated at about 50Ω, for example. Furthermore, the outer electrode 14b is used as a second coupling port and the outer electrode 14d is used as a termination port that is terminated at about 50Ω, for example. The outer electrodes 14e and 14f are used as ground ports, which are grounded. When a signal is input to the outer electrode 14g, the signal is output from the outer electrode 14h. Furthermore, since the main line M and the sub-lines S1 and S2 are electromagnetically coupled with each other, a signal having a power that is proportional to the power of the input signal is output from the outer electrodes 14b and 14c.

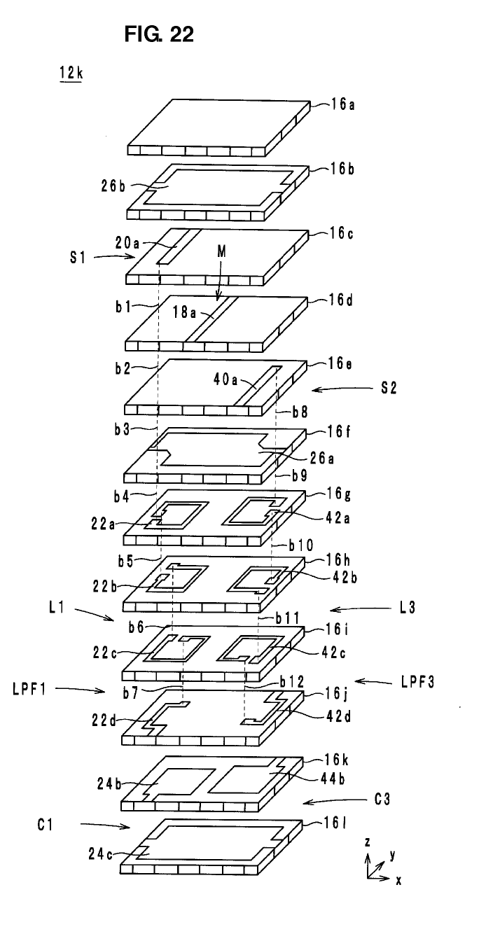

Next, a specific configuration of the directional coupler 10k will be described while referring to the drawings. FIG. 22 is an exploded perspective view of a multilayer body 12k of the directional coupler 10k according to the eleventh preferred embodiment. FIG. 12 will be used as an external perspective view of the directional coupler 10k.

The directional coupler 10k, as illustrated in FIG. 12 and FIG. 22, includes the multilayer body 12k, the outer electrodes 14 (14a to 14h), the main line M, the sub-lines S1 and S2, the low pass filters LPF1 and LPF3 and shielding conductor layers 26a and 26b. The multilayer body 12k, as illustrated in FIG. 12, preferably has a rectangular parallelepiped shape, and, as illustrated in FIG. 22, and preferably is formed by the insulator layers 16 (16a to 16l) being stacked in this order from the positive side to the negative side in the z-axis direction. The insulator layers 16 preferably are dielectric ceramic layers having a rectangular or substantially rectangular shape, for example.

The outer electrodes 14a, 14h and 14b are provided on a lateral surface of the multilayer body 12k on the positive side in the y-axis direction so as to be adjacent to one another in this order from the negative side to the positive side in the x-axis direction. The outer electrodes 14c, 14g and 14d are provided on a lateral surface of the multilayer body 12k on the negative side in the y-axis direction so as to be adjacent to one another in this order from the negative side to the positive side in the x-axis direction.

The main line M, as illustrated in FIG. 22, preferably includes the line portion 18a. The line portion 18a is a line-shaped conductor layer that is provided on the insulator layer 16d. The line portion 18a extends in the y-axis direction and is connected to the outer electrodes 14g and 14h. In this way, the main line M is connected between the outer electrodes 14g and 14h.

The sub-line S1, as illustrated in FIG. 22, preferably includes the line portion 20a and the via hole conductors b1 to b4. The line portion 20a is a line-shaped conductor layer that is provided on the insulator layer 16c on the negative side of the line portion 18a in the x-axis direction when viewed in plan from the positive side in the z-axis direction. The line portion 20a extends in the y-axis direction parallel to the line portion 18a and is connected to the outer electrode 14a. Thus, the main line M and the sub-line S1 are electromagnetically coupled with each other. The via hole conductors b1 to b4 penetrate through the insulator layers 16c to 16f in the z-axis direction and are connected to one another. In addition, the via hole conductor b1 is connected to an end portion of the line portion 20a on the negative side in the y-axis direction.

The low pass filter LPF1 preferably includes the coil L1 and the capacitor C1. The coil L1 preferably includes the line portions 22 (22a to 22d) and the via hole conductors b5 to b7 and has a spiral shape that loops in the counterclockwise direction while advancing from the positive side to the negative side in the z-axis direction. Here, in the coil L1, an end portion on the upstream side in the counterclockwise direction is termed an upstream end and an end portion on the downstream side in the counterclockwise direction is termed a downstream end. The line portion 22a is a line-shaped conductor layer that is provided on the insulator layer 16g and the upstream end thereof is connected to the via hole conductor b4. The line portions 22b and 22c are line-shaped conductor layers that are provided on the insulator layers 16h and 16i, respectively. The line portion 22d is a line-shaped conductor layer that is provided on the insulator layer 16j and the downstream end thereof is connected to the outer electrode 14c. The via hole conductor b5 penetrates through the insulator layer 16g in the z-axis direction and connects the downstream end of the line portion 22a and the upstream end of the line portion 22b to each other. The via hole conductor b6 penetrates through the insulator layer 16h in the z-axis direction and connects the downstream end of the line portion 22b and the upstream end of the line portion 22c to each other. The via hole conductor b7 penetrates through the insulator layer 16i in the z-axis direction and connects the downstream end of the line portion 22c and the upstream end of the line portion 22d to each other. In this way, the coil L1 is connected between the sub-line S1 and the outer electrode 14c.

The capacitor C1 includes planar conductor layers 24 (24b and 24c). The planar conductor layer 24c is arranged so as to cover substantially the entire surface of the insulator layer 16l and is connected to the outer electrodes 14e and 14f. The planar conductor layer 24b is provided on the insulator layer 16k and is connected to the outer electrode 14c. The planar conductor layer 24b preferably has a rectangular or substantially rectangular shape and is superposed with the planar conductor layer 24c when viewed in plan from the z-axis direction. In this way, a capacitance is generated between the planar conductor layer 24c and the planar conductor layer 24b. The capacitor C1 is connected between the outer electrode 14c and the outer electrodes 14e and 14f. That is, the capacitor C1 is connected between a point between the coil L1 and the outer electrode 14c, and the outer electrodes 14e and 14f.

The sub-line S2, as illustrated in FIG. 22, includes a line portion 40a and the via hole conductors b8 and b9. The line portion 40a is a line-shaped conductor layer that is provided on the insulator layer 16e on the positive side of the line portion 18a in the x-axis direction when viewed in plan from the positive side in the z-axis direction. The line portion 40a extends in the y-axis direction parallel to the line portion 18a and is connected to the outer electrode 14d. Thus, the main line M and the sub-line S2 are electromagnetically coupled with each other. The via hole conductors b8 and b9 penetrate through the insulator layers 16e and 16f in the z-axis direction and are connected to each other. In addition, the via hole conductor b8 is connected to an end portion of the line portion 40a on the positive side in the y-axis direction.

The low pass filter LPF3 includes the coil L3 and the capacitor C3. The coil L3 includes line portions 42 (42a to 42d) and the via hole conductors b10 to b12 and has a spiral shape that loops in the counterclockwise direction while advancing from the positive side to the negative side in the z-axis direction. Here, in the coil L3, an end portion on the upstream side in the counterclockwise direction is termed an upstream end and an end portion on the downstream side in the counterclockwise direction is termed a downstream end. The line portion 42a is a line-shaped conductor layer that is provided on the insulator layer 16g and the upstream end thereof is connected to the via hole conductor b9. The line portions 42b and 42c are line-shaped conductor layers that are provided on the insulator layers 16h and 16i, respectively. The line portion 42d is a line-shaped conductor layer that is provided on the insulator layer 16j and the downstream end thereof is connected to the outer electrode 14b. The via hole conductor b10 penetrates through the insulator layer 16g in the z-axis direction and connects the downstream end of the line portion 42a and the upstream end of the line portion 42b to each other. The via hole conductor b11 penetrates through the insulator layer 16h in the z-axis direction and connects the downstream end of the line portion 42b and the upstream end of the line portion 42c to each other. The via hole conductor b12 penetrates through the insulator layer 16i in the z-axis direction and connects the downstream end of the line portion 42c and the upstream end of the line portion 42d to each other. In this way, the coil L3 is connected between the sub-line S2 and the outer electrode 14d.

The capacitor C3 includes planar conductor layers 44b and 24c. The planar conductor layer 24c is arranged so as to cover substantially the entire surface of the insulator layer 16l and is connected to the outer electrodes 14e and 14f. The planar conductor layer 44b is provided on the insulator layer 16k and is connected to the outer electrode 14b. The planar conductor layer 44b preferably has a rectangular or substantially rectangular shape and is superposed with the planar conductor layer 24c when viewed in plan from the z-axis direction. In this way, a capacitance is generated between the planar conductor layer 24c and the planar conductor layer 44b. The capacitor C3 is connected between the outer electrode 14b and the outer electrodes 14e and 14f. That is, the capacitor C3 is connected between a point between the coil L3 and the outer electrode 14b, and the outer electrodes 14e and 14f.

The shielding conductor layers 26a and 26b are arranged so as to cover substantially the entire surfaces of the insulator layers 16f and 16b and are connected to the outer electrodes 14e and 14f. That is, a ground potential is applied to the shielding conductor layers 26a and 26b. The shielding conductor layer 26a is provided between the main line M and the sub-lines S1 and S2, and the coils L1 and L3 in the z-axis direction, whereby electromagnetic coupling between the sub-lines S1 and S2 and the coils L1 and L3 is prevented and suppressed.

### Twelfth Preferred Embodiment

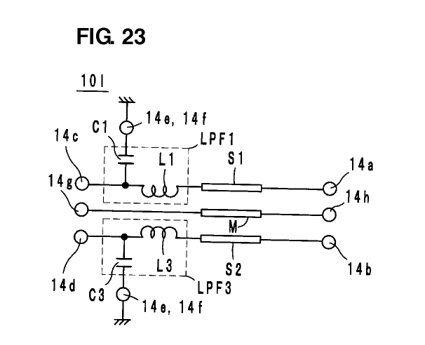

Hereafter, the configuration of a directional coupler 10l according to a twelfth preferred embodiment will be described while referring to the drawings. FIG. 23 is an equivalent circuit diagram of the directional coupler 10l according to the twelfth preferred embodiment.

The circuit configuration of the directional coupler 10l will now be described. The directional coupler 10l is equipped with the outer electrodes (terminals) 14a to 14h, the main line M, the sub-lines S1 and S2 and the low pass filters LPF1 and LPF3, as a circuit configuration. The configurations of the main line M, the sub-line S1 and the low pass filter LPF1 of the directional coupler 10l are similar to those of the main line M, the sub-line S1 and the low pass filter LPF1 of the directional coupler 10k and therefore description thereof will be omitted.

In addition, the low pass filter LPF3 is connected between the outer electrode 14d and the sub-line S2 and has a characteristic that attenuation increases with increasing frequency in a predetermined frequency band. The low pass filter LPF3 includes the capacitor C3 and the coil L3. The coil L3 is connected in series between the outer electrode 14d and the sub-line S2. The capacitor C3 is connected between a point between the sub-line S2 and the outer electrode 14d (more precisely a point between the coil L3 and the outer electrode 14d), and the outer electrodes 14e and 14f.

In the above-described directional coupler 10l, the outer electrode 14g is used as an input port and the outer electrode 14h is used as an output port. Furthermore, the outer electrode 14c is used as a first coupling port and the outer electrode 14a is used as a termination port that is terminated at 50Ω. Furthermore, the outer electrode 14d is used as a second coupling port and the outer electrode 14b is used as a termination port that is terminated at about 50Ω, for example. The outer electrodes 14e and 14f are used as ground ports, which are grounded. When a signal is input to the outer electrode 14g, the signal is output from the outer electrode 14h. Furthermore, since the main line M and the sub-line S1 are electromagnetically coupled with each other, a signal having a power that is proportional to the power of the input signal is output from the outer electrode 14c.

Here, a signal output from the outer electrode 14h is partially reflected by an antenna or the like connected to the outer electrode 14h. Such a reflected signal is input to the main line M from the outer electrode 14h. Since the main line M and the sub-line S2 are electromagnetically coupled with each other, a signal having a power that is proportional to the power of a reflected signal input from the outer electrode 14d is output from the outer electrode 14d.

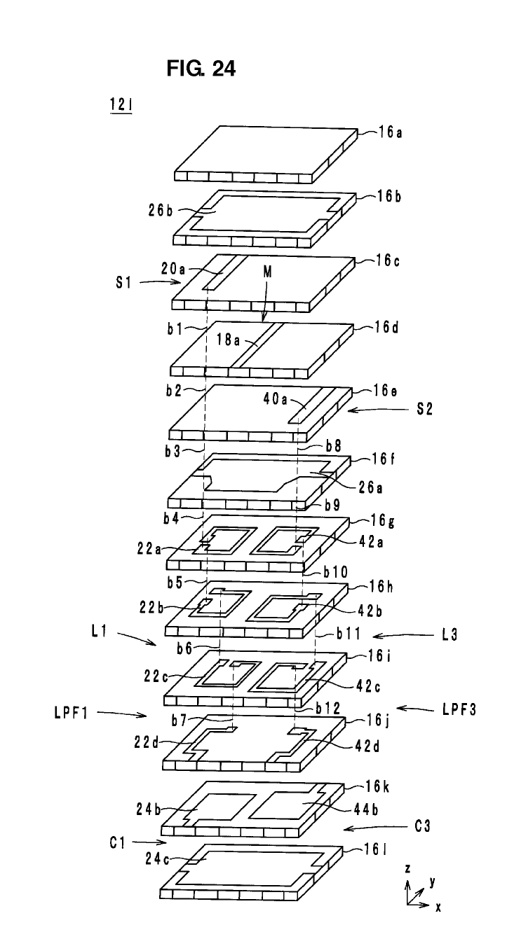

Next, a specific configuration of the directional coupler 10l will be described while referring to the drawings. FIG. 24 is an exploded perspective view of a multilayer body 12l of the directional coupler 10l according to the twelfth preferred embodiment. FIG. 12 will be used as an external perspective view of the directional coupler 10l.

The directional coupler 10l, as illustrated in FIG. 12 and FIG. 24, preferably includes the multilayer body 12l, the outer electrodes 14 (14a to 14h), the main line M, the sub-lines S1 and S2, the low pass filters LPF1 and LPF3 and the shielding conductor layers 26a and 26b. The multilayer body 12l, as illustrated in FIG. 12, preferably has a rectangular parallelepiped shape, and, as illustrated in FIG. 24, and preferably is formed by the insulator layers 16 (16a to 16l) being stacked in this order from the positive side to the negative side in the z-axis direction. The insulator layers 16 preferably are dielectric ceramic layers having a rectangular or substantially rectangular shape, for example.

The outer electrodes 14a, 14h and 14b are provided on a lateral surface of the multilayer body 12l on the positive side in the y-axis direction so as to be adjacent to one another in this order from the negative side to the positive side in the x-axis direction. The outer electrodes 14c, 14g and 14d are provided on a lateral surface of the multilayer body 12l on the negative side in the y-axis direction so as to be adjacent to one another in this order from the negative side to the positive side in the x-axis direction.

The main line M, as illustrated in FIG. 6, includes the line portion 18a. The line portion 18a is a line-shaped conductor layer that is provided on the insulator layer 16d. The line portion 18a extends in the y-axis direction and is connected to the outer electrodes 14g and 14h. In this way, the main line M is connected between the outer electrodes 14g and 14h.

The configurations of the main line M, the sub-line S1 and the low pass filter LPF1 of the directional coupler 10l preferably are similar to those of the main line M, the sub-line S1 and the low pass filter LPF1 of the directional coupler 10k and therefore description thereof will be omitted.

The sub-line S2, as illustrated in FIG. 24, includes the line portion 40a and the via hole conductors b8 and b9. The line portion 40a is a line-shaped conductor layer that is provided on the insulator layer 16e on the positive side of the line portion 18a in the x-axis direction when viewed in plan from the positive side in the z-axis direction. The line portion 40a extends in the y-axis direction parallel to the line portion 18a and is connected to the outer electrode 14b. Thus, the main line M and the sub-line S2 are electromagnetically coupled with each other. The via hole conductors b8 and b9 penetrate through the insulator layers 16e and 16f in the z-axis direction and are connected to each other. In addition, the via hole conductor b8 is connected to an end portion of the line portion 40a on the negative side in the y-axis direction.

The low pass filter LPF3 includes the coil L3 and the capacitor C3. The coil L3 includes the line portions 42 (42a to 42d) and the via hole conductors b10 to b12 and has a spiral shape that loops in the clockwise direction while advancing from the positive side to the negative side in the z-axis direction. Here, in the coil L3, an end portion on the upstream side in the clockwise direction is termed an upstream end and an end portion on the downstream side in the clockwise direction is termed a downstream end. The line portion 42a is a line-shaped conductor layer that is provided on the insulator layer 16g and the upstream end thereof is connected to the via hole conductor b9. The line portions 42b and 42c are line-shaped conductor layers that are provided on the insulator layers 16h and 16i, respectively. The line portion 42d is a line-shaped conductor layer that is provided on the insulator layer 16j and the downstream end thereof is connected to the outer electrode 14d. The via hole conductor b10 penetrates through the insulator layer 16g in the z-axis direction and connects the downstream end of the line portion 42a and the upstream end of the line portion 42b to each other. The via hole conductor b11 penetrates through the insulator layer 16h in the z-axis direction and connects the downstream end of the line portion 42b and the upstream end of the line portion 42c to each other. The via hole conductor b12 penetrates through the insulator layer 16i in the z-axis direction and connects the downstream end of the line portion 42c and the upstream end of the line portion 42d to each other. In this way, the coil L3 is connected between the sub-line S2 and the outer electrode 14d.

The capacitor C3 preferably includes the planar conductor layers 44b and 24c. The planar conductor layer 24c is arranged so as to cover substantially the entire surface of the insulator layer 16l and is connected to the outer electrodes 14e and 14f. The planar conductor layer 44b is provided on the insulator layer 16k and is connected to the outer electrode 14b. The planar conductor layer 44b preferably has a rectangular or substantially rectangular shape and is superposed with the planar conductor layer 24c when viewed in plan from the z-axis direction. In this way, a capacitance is generated between the planar conductor layer 24c and the planar conductor layer 44b. The capacitor C3 is connected between the outer electrode 14b and the outer electrodes 14e and 14f. That is, the capacitor C3 is connected between a point between the coil L3 and the outer electrode 14b, and the outer electrodes 14e and 14f.

The shielding conductor layer 26a is arranged so as to cover substantially the entire surface of the insulator layer 16f and is connected to the outer electrodes 14e and 14f. That is, a ground potential is applied to the shielding conductor layer 26a. The shielding conductor layer 26a is provided between the main line M and the sub-lines S1 and S2, and the coils L1 and L3 in the z-axis direction, whereby electromagnetic coupling between the sub-lines S1 and S2 and the coils L1 and L3 is prevented and suppressed.

In the directional couplers 10a to 10l, the main line M and the sub-lines S, S1 and S2, and the low pass filters LPF1, LPF2 and LPF3 are arranged so as to be adjacent to one another in the z-axis direction. However, the positional relationship between the main line M and the sub-lines S, S1 and S2 and the low pass filters LPF1, LPF2 and LPF3 is not limited to this. For example, the main line M, the sub-lines S, S1 and S2 and the low pass filters LPF1, LPF2 and LPF3 may be arranged so as to be adjacent to one another in x-axis direction or the y-axis direction.

The directional couplers 10a to 10l preferably are, for example, multilayer electronic components formed by stacking insulator layers 16, which are composed of a dielectric ceramic, on top of one another. However, the directional couplers 10a to 10l do not need to be multilayer electronic components. For example, the directional couplers 10a to 10l may include semiconductor chips. The number of stacked layers of a semiconductor chip would be fewer than that of a multilayer electronic component. Accordingly, arranging the main line M, the sub-lines S, S1 and S2, and the low pass filters LPF1, LPF2 and LPF3 so as to be adjacent to one another in the z-axis direction would be difficult. Therefore, in this case, it would preferable that the main line M, the sub-lines S, S1 and S2, and the low pass filters LPF1, LPF2 and LPF3 be arranged adjacent to one another in the x-axis direction or the y-axis direction.

In addition, in the directional couplers 10a to 10l, 824 MHz to 1910 MHz, for example, was preferably adopted as a predetermined frequency band. However, the predetermined frequency band is not limited to this. For example, in the case of WCDMA, any of the following six frequency bands can be adopted as the frequency band of a signal input to the directional couplers 10a to 10l.

Band 5: 824 MHz to 849 MHz

Band 8: 880 MHz to 915 MHz

Band 3: 1710 MHz to 1785 MHz

Band 2: 1850 MHz to 1910 MHz

Band 1: 1920 MHz to 1980 MHz

Band 7: 2500 MHz to 2570 MHz

Therefore, the predetermined frequency band is a frequency band obtained by appropriately combining the above six frequency bands. For example, a frequency band obtained by combining Band 1, Band 2, Band 3, Band 5 and Band 8 is from 824 MHz to 915 MHz and from 1710 MHz to 1980 MHz. Therefore, the predetermined frequency band in this case is 824 MHz to 1980 MHz.

As described above, preferred embodiments of the present invention are useful for directional couplers and are particularly excellent in that the degree of coupling characteristic can be close to constant.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A directional coupler to be used in a predetermined frequency band, comprising:
first to fourth terminals;
a main line that is connected between the first terminal and the second terminal;
a first sub-line that is connected between the third terminal and the fourth terminal and that is electromagnetically coupled with the main line; and
a first low pass filter that is connected between the third terminal and the first sub-line and has a characteristic in which attenuation increases with increasing frequency in the predetermined frequency band.

2. The directional coupler according to claim 1, wherein the first terminal is an input terminal to which a signal is input, the second terminal is a first output terminal from which the signal is output, the third terminal is a second output terminal from which a signal having a power that is proportional to the power of the signal is output, and the fourth terminal is a termination terminal that is terminated.

3. The directional coupler according to claim 1, further comprising a fifth terminal that is a ground terminal, wherein the first low pass filter includes a first capacitor that is connected between a point between the third terminal and the first sub-line, and the fifth terminal.

4. The directional coupler according to claim 3, wherein the first low pass filter further includes a first coil, which is connected in series between the third terminal and the first sub-line.

5. The directional coupler according to claim 4, wherein the first capacitor is connected between a point between the first coil and the first sub-line, and the fifth terminal.

6. The directional coupler according to claim 1, further comprising a second low pass filter that is connected between the fourth terminal and the first sub-line and has a characteristic in which attenuation increases with increasing frequency in the predetermined frequency band.

7. The directional coupler according to claim 6, further comprising a fifth terminal and a sixth terminal that are termination terminals that are terminated, wherein the first low pass filter includes a first coil that is connected in series between the third terminal and the first sub-line and a first capacitor that is connected between a point between the third terminal and the first sub-line, and the fifth terminal, and the second low pass filter includes a second coil that is connected in series between the fourth terminal and the first sub-line and a second capacitor that is connected between a point between the fourth terminal and the first sub-line, and the sixth terminal.

8. The directional coupler according to claim 7, wherein the first capacitor is connected between a point between the first coil and the first sub-line, and the fifth terminal, and the second capacitor is connected between a point between the second coil and the first sub-line, and the sixth terminal.

9. The directional coupler according to claim 6, further comprising a seventh terminal that is a ground terminal and a termination resistor that is connected to the ground terminal, wherein the first low pass filter includes a first coil that is connected in series between the third terminal and the first sub-line and a first capacitor that is connected between a point between the third terminal and the first sub-line, and the termination resistor, and the second low pass filter includes a second coil that is connected in series between the fourth terminal and the first sub-line and a second capacitor that is connected between a point between the fourth terminal and the first sub-line, and the termination resistor.

10. The directional coupler according to claim 9, wherein the first capacitor is connected between a point between the first coil and the first sub-line, and the termination resistor, and the second capacitor is connected between a point between the second coil and the first sub-line, and the termination resistor.

11. The directional coupler according to claim 1, further comprising a multilayer body including a plurality of insulator layers stacked on top of one another, wherein the main line, the first sub-line and the first low pass filter are defined by conductor layers provided on the insulator layers.

12. The directional coupler according to claim 11, wherein the main line and the first sub-line oppose each other with one of the insulator layers disposed therebetween.

13. The directional coupler according to claim 11, further comprising a fifth terminal that is a ground terminal, wherein the first low pass filter includes a first coil that is connected in series between the third terminal and the first sub-line and a first capacitor that is connected between a point between the third terminal and the first sub-line, and the fifth terminal, and the directional coupler further includes a shielding conductor layer that is provided between the main line and the first sub-line, and the first coil in a direction in which the layers are stacked and to which a ground potential is applied.

14. The directional coupler according to claim 13, wherein the first capacitor further includes a planar conductor layer, the main line and the first sub-line being interposed between the planar conductor layer and the shielding conductor layer in the direction in which the layers are stacked and a ground potential being applied to the planar conductor layer.

15. The directional coupler according to claim 13, wherein the first capacitor further includes a planar conductor layer, the first coil being interposed between the planar conductor layer and the shielding conductor layer in the direction in which the layers are stacked and a ground potential being applied to the planar conductor layer.

16. The directional coupler according to claim 11, wherein the main line or the first sub-line and the first low pass filter are arranged so as to be adjacent to each other in a direction perpendicular or substantially perpendicular to the direction in which the layers are stacked.

17. The directional coupler according to claim 1, further comprising an eighth terminal and a ninth terminal, a second sub-line that is connected between the eighth terminal and the ninth terminal and that is electromagnetically coupled with the main line, and a third low pass filter that is connected between the ninth terminal and the second sub-line and has a characteristic in which attenuation increases with increasing frequency in the predetermined frequency band.

18. The directional coupler according to claim 1, further comprising an eighth terminal and a ninth terminal, a second sub-line that is connected between the eighth terminal and the ninth terminal and that is electromagnetically coupled with the main line, and a third low pass filter that is connected between the eighth terminal and the second sub-line and has a characteristic that attenuation increases with increasing frequency in the predetermined frequency band.
